(19) United States
(12) Patent Application Publication
(10) Pub. No.: US 2004/0091596 A1
(43) Pub. Date: May 13, 2004

(54) Food product and method of manufacture

(76) Inventors: Steve Schellhaass, Plymouth, MN (US); Leslie Skarra, Cape Coral, FL (US); John Yasosky, Maple Grove, MN (US); R. Carl Hoseney, Manhattan, KS (US)

Correspondence Address: BLACKWELL SANDERS PEPER MARTIN LLP, 720 OLIVE STREET, SUITE 2400, ST. LOUIS, MO, 63101, US

(21) Appl. No.: 10/294,542

(22) Filed: Nov. 13, 2002

(51) Int. Cl. A21D 10/00

(52) U.S. Cl. 426/549

(57) ABSTRACT

A starch based cooked food product that is resistant to degradation during storage. The food product includes modified starch in an amount sufficient to reduce the degradation rate of a stored cooked food product. A method is provided for making the cooked food product.

### BACKGROUND OF INVENTION

Starch based food items are made from flour and/or masa, e.g., cereal grain flour or masa or flour from legumes (cereal grains and legumes are referred to collectively as grain(s) for convenience) like soybeans and combinations thereof as a majority of the flour or masa. Cereal grains include wheat, corn, barley, triticale, rye, oats, etc. Generally the flour or masa includes a protein component and a starch component. Products such as tortillas and other relatively thin bread-like food products such as pocket, flat and pita breads are made by forming a plastic mass (dough) of the flour and/or masa and a plasticizing agent including water and oftentimes fat in varying amounts and other well known ingredients. The plastic mass is then formed into an appropriately sized and shaped product precursor or preform which is then cooked. Generally, cooking of the precursor gelatinizes the starch. Gelatinization is generally considered to be the loss of birefringence of the starch cells under polarized light, i.e., the starch is no longer considered to be crystalline. Gelatinization is the absorption of water into the starch cells to the degree that crystallinity is lost in a substantial portion of the starch as measured by the loss of birefringence as is well known. The manufacture of such food products is well known in the industry.

Major problems with grain based food items include firming and staling (collectively degradation). Degradation, as used herein is inclusive of firming and/or staling. Much literature has been written and much research has been conducted to both explain and reduce the problems of product degradation with age. Generally, degradation results in a product that is perceived by a consumer as less desirable to eat than a freshly made product. The degraded product has a firmer texture and appears to have dried; it can become brittle and crack when bent as well as exhibit other negative attributes. Today, it is believed that staling is starch recrystalization and firming is an interaction between starch and protein. However, the terms are often used interchangeably and to a consumer, the technical distinction is not relevant since both result in decreased eating and using quality with age. Also, it is oftentimes difficult to tell which of staling and firming is occurring to cause loss of quality. As mentioned, a degraded product can also be brittle, i.e., cracks when folded, thereby losing integrity in the cooked product as for example, in a tortilla. This is particularly noticeable in thin products which have a bread-like structure as in tortillas and the like as opposed to those that have a crumb structure like cakes and pancakes (both of which are batter based). The cooked bread-like products generally have a leavened internal structure, i.e., contain numerous small voids expanded by leavening gases which can be produced by yeast, chemical leaveners and even steam during the cooking process.

Degradation is complex and not very well understood physiochemical processes. Staling has been attributed to retrogradation which is a re-crystallization of the starch. A discussion of the staling problem can be found in U.S. Pat. No. 4,961,937 to Harry W. Rudel. As is evidenced by this patent and much of the literature and patents related to the reduction of staling, many attempts have been made to solve this problem. However, the shelf life of bread-like items has in large part not been appreciably improved in recent years. Degradation, whether it is either or both of firming and staling is a major problem since it limits the shelf-life of such products generally to a matter of a few days when stored under refrigerated or ambient conditions.

Articles have been written discussing shelf life attributes of flour or starch based items and possible solutions to shelf life problems. For example, an article entitled Effects of Additives and Storage Temperature on Staling Properties of Bagels, by P. J. Lent and L. A. Grant was published in Cereal Chem 78 (5): 619-624. While the article discusses the textural attributes changes over shelf life of bagels, it was concluded on page 623 that “instant Tender-Jel C starch was not superior to any of the additives used for this study and, thus, would not be recommended as an additive for further studies in this application due to its chemical modification.” Further, the test period was only over a 7 day period. It also appears from this article that the test used tested the toughness of the crust and not the firming of the food product. U.S. Pat. No. 4,615,888 is directed to using a specific genotype starch as an anti-stalant in breads. The patent tested both loaf bread items made from dough and other items made from a batter for example a corn muffin. An article entitled Substitution of Wheat Starch with Non-Wheat Starches and Cross-linked Waxy Barley Starch Effects Central Properties in Staling in Arabic Bread, see J. Sci. Food Agric. 79: 1855-1860 (1999) authored by Toufeili et al. discusses staling. In one series of tests reported it appears that all of the native starch was substituted by a cross-linked waxy barley starch. The conclusion of this article was that the waxy barley starch breads (made with crosslinked and modified waxy barley starches) staled faster than regular wheat bread using native wheat starch. Another article entitled Effects of Partial Replacement of Rice Flour with Chemically Stabilized Rice Starches on the Textural Characteristics of the Storage Stability of Korean Plain Rice Cake, published in Foods and Biotechnology Volume 5, No. 4, Pages 268-273 (1996) by Chung et al. discusses texture and storage stability. These products do not appear to be bread-like but rather a mass of rice molded together after cooking.

According to a product brochure from Penford Food Ingredients Co. a modified potato starch was recommended for use in wheat flour tortillas to extend the refrigerated shelf life. They claim that by using the formula listed, that shelf life under refrigerated conditions can be extended by 44%. The ingredient, PenPlus MG is believed to be a modified starch as that term is used herein and is useable in full/low fat tortillas. The brochure also recommends the use of PenPlus 951 for no fat tortillas. The brochure claims that PenPlus MG is an unmodified but pregellatinized potato starch. They do not describe PenPlus 951 in the brochure. According to the cited data, the PenPlus MG used in a 9% fat tortilla increased the refrigerated shelf life from what appears to be a shelf life of 9 days at best to approximately 14 days at best. The PenPlus MG in the formula is used at a very low concentration of less than 2% by weight of the total product.

Generally, storing products under refrigerated conditions, e.g., at a temperature of about 40° F. is the optimum temperature for the occurrence of degradation. By contrast however, it is known that some tortillas degrade faster at room temperature, for example, 70°-75° F. than they do at refrigerated conditions. The reason for this is not known.

With regard to tortillas, U.S. Pat. No. 4,735,811 provides an advance in the art of increasing shelf life for tortillas stored at refrigerated temperatures. However, this technology does not provide a shelf life as long as is desired for current distribution system restraints.

The extension of a few weeks can dramatically improve the manufacturer's ability to distribute bread-like items providing increased quality and reduced waste particularly tortillas stored under ambient conditions. Thus, there is a need for starch based food products that exhibit a reduced tendency to degrade while in the distribution system or in the possession of consumers.

### SUMMARY OF INVENTION

The present invention involves the provision of flour (from seed crop) and/or masa based bread-like products such as tortillas that exhibit increased shelf life through a resistance to degradation. A portion of the flour and/or masa component of the ingredients used to make the food products includes modified starch (from a seed crop or other source). The starch may be modified by pre-gelatinization and/or hydroxypropyllation and/or crosslinking and/or oxidation.

A modified starch is added to the ingredients used to form the precursor to the cooked product for example a sheeted and die cut dough piece which later is cooked to form, for example, a tortilla.

The flour based food product of the present invention exhibits a reduction in the rate of degradation providing a shelf life of at least about 30 days under storage conditions ranging from frozen to ambient storage, including refrigerated storage, on the shelf either at a retail outlet, manufacturer's storage and/or consumer storage.

The present invention also involves the provision of a method of making a flour and/or masa (from seed crop) based food product having improved resistance to degradation and a resultant increase in shelf life.

### BRIEF DESCRIPTION OF DRAWINGS

FIG. 1 is a flow chart showing two processes of making a degradation resistant flour based cooked food product tortilla with increased shelf life.

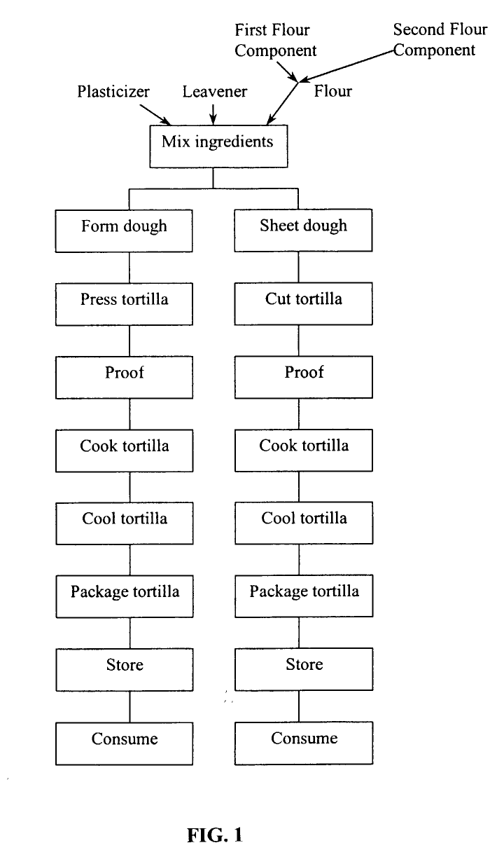

### DETAILED DESCRIPTION

### The Precursor

A dough is made by mixing comminuted starch and/or protein containing material such as flour and/or masa and a plasticizing agent. “Comminuted material” as used herein includes materials, including starch and/or protein, derived from cereal grain, legumes and tubers and is in the form of a fine and/or coarse particles and can be in the form of flour and/or masa. Typically the plasticizing agent includes water, may include lipids such as vegetable or animal shortenings or oils and may also include polyhydric alcohols such as glycerin. Sufficient plasticizer is added to form a plastic mass (dough) of the plasticizing agent and comminuted material and to provide the desired final texture and eating attributes.

The total comminuted material is present in the dough in the range of between about 60% and about 40% preferably in the range of between about 55% and about 45% and most preferably in the range of between about 53% and about 47% by weight of the comminuted material (on a dry weight basis) and plasticizer. The comminuted material will contain starch and protein and can be derived from a cereal grain such as corn, oats, wheat, barley, rye, triticale, etc., and/or a legume such as soybeans and/or tubers such as potatoes or combinations of cereal grains, tubers and legumes. Tubers, particularly potatoes, though can provide a noticeable off taste in the finished product and the amount usable is limited at least by taste considerations. Cereal grains, tubers and legumes are referred to collectively herein as seed crops and cereal grains and legumes are referred to collectively herein as grains. Wheat flour is preferred for many products and when used, a majority of the comminuted material is wheat flour.

The total comminuted material is comprised of at least two components. The first component is the ground native seed crop and is substantially unmodified except for grinding the seed crop, i.e., the naturally occurring starch and protein are substantially unchanged (except for starch damaged during grinding) from their natural state. At least a majority of the first component is from seed crops, preferably from grain and most preferably from cereal grain. The first component may however, have additives or may be processed, e.g., bromated, bleached, etc. The first component will have some naturally occurring water. The second component of the comminuted material is added starch and perhaps added protein. The second component may be derived from seed crop and preferably grains. The added starch is a modified starch which modification can be physical or chemical. Preferably, the modification is done prior to forming the dough and cooking of the product. Physical modification can be by pre-gelatinization. Chemical modification can be by crosslinking, oxidation and/or substitution. Crosslinking reactions of the starch react two or more hydroxyl groups within the starch granule and between starch molecules resulting in a stronger swelled granule with tolerance to high shear and heat. Typical crosslinking reagents include phosphorous oxychloride, sodium trimetaphosphate and certain anhydrides such as adipic and acetic. Substitution reactions lower the gelatinization temperature of the starch granule and inhibit reassociation of polymers after cooking. The inhibition of the polymer reassociation that is thought to be linked to degradation, is done by chemically substituting groups along the starch polymer backbone. Typical chemical groups used for substitution are acetyl, succinyl, phosphate and hydroxypropyl groups. Hydroxypropyllation is an effective modification. Oxidation modification is well known and can be accomplished through the use of sodium hypochlorite. Preferably, with particular regard to wheat tortillas as described hereinbelow, multiple types of modified starches may be used including pre-gelatinized (as indicated by loss of birefringence) and hydroxypropyllated starches. Preferably the starch is from grain although tuber starch may be used within shelf life and taste constraints. The modified starch is added to the first flour component wherein the modified starch (on a dry weight basis) is present in an amount with adequate functionality to achieve the below described shelf life. The modified starch is present in a ratio to the first component starch in the range of between about 1.2:1 and about 1:50, preferably in the range of between about 1:1.2 and about 1:20, and most preferably in the range of between about 1:3 and about 1:11 by dry weight of the starch in the first component. The weight percents and ratios of the dry ingredients are on a dry weight basis, i.e., no water, or a ratio of ingredient to ingredient, both being on a dry weight basis. These ratios of starches are for both the cooked product and in the dough. With regard to the total comminuted material used (the first component plus the second component), the modified starch is present in the amount of between about 40% and about 1% preferably in the range of between about 30% and about 1% and most preferably in the range of between about 25% and about 1% by weight of total comminuted material on a dry weight basis.

Protein may also be added to the comminuted material. In the manufacture of a finished product using the present invention, it has been found convenient to short the recipe on some of its required comminuted material for conventional recipes. The shorted portion of the recipe is then made up for by adding the modified starch and protein if additional protein is desired. It is to be understood that higher protein comminuted material could be provided in the first component and protein need not be added to the comminuted material since adequate protein would be present to prepare the particular recipe and make the desired cooked product. Protein may be added when necessary to make up for any protein missing from shorting the recipe of the originally required comminuted material. The amount of added protein will be determined by the amount of protein shorted in the recipe and/or the total amount of protein needed. In the case of wheat based tortillas and other thin bread-like items the total protein, which is mainly gluten, content in the total comminuted material is in the range of between about 20% and about 10% preferably in the range of between about 18% and about 12% and most preferably in the range of between about 16% and about 14% by weight of total flour on a dry weight basis. The remainder of the comminuted material is the total starch component.

In the case of thin bread-like items exclusive of tortillas, for example, flat bread, pita bread, pocket bread and the like, the total comminuted material (on a dry weight basis) is present in the precursor in the range of between about 65% and about 35% preferably in the range of between about 60% and about 40% and most preferably in the range of between about 55% and about 45% by weight of total comminuted material (on a dry weight basis) and plasticizer.

The plasticizing agent is present in the precursor mass in an amount sufficient to form a dough in combination with the (total) comminuted material and to provide the desired cooked product attributes. The total water content in the dough in the case of a tortilla is in the range of between about 125% and about 50% preferably in the range of between about 95% and about 60% and most preferably in the range of between about 85% and about 70% by weight of total comminuted material on a dry weight basis. In the case of thin bread-like items exclusive of tortillas, e.g., pita bread, flat bread and pocket bread the water is present in the range of between about 125% and about 50% preferably in the range of between about 100% and about 60% and most preferably in the range of between about 95% and about 70% by weight of total comminuted on a dry weight basis.

Other plasticizers such as lipids and/or polyhydric alcohols can be added to the comminuted material to help plasticize the comminuted material and/or provide a desired eating texture and taste. In the case of a tortilla, lipids (if any) can be added in the range of between about 20% and about 0% preferably in the range of between about 15% and about 5% and most preferably in the range of between about 12% and about 8% by weight of total comminuted material (on a dry weight basis). In the case of bread-like items of this invention, lipids (if any) can be present in the range of between about 20% and about 0% preferably in the range of between about 15% and about 5% and most preferably in the range of between about 12% and about 8% by weight of total comminuted material on a dry weight basis. Lipids can be vegetable and/or animal shortenings or oils. The particular lipid(s) and amount used will depend on the texture desired and the product being made.

A preferred modified starch is a wheat starch particularly for wheat based items because of taste considerations. However other modified starches can be added and do not necessarily have to be derived from the seed crop used as the first component of the flour. Further, the first component can be a combination of different cereal grain flours and/or legume flours and/or tuber flours as desired.

Other ingredients may be added to the dough for example nutrients, fortifiers, flavors, salt, etc. as is known in the art.

Leavening agents such as yeast and/or chemical leaveners may also be added to the dough. The yeast can be introduced via either the sponge dough method or the straight dough method as are known in the art. If yeast or chemical leaveners are used, the dough is typically allowed to rise to develop the cellular structure desired during the processing of the dough.

After forming the dough, the dough is then processed in any desirable manner to form the desired end cooked food product. In the case of a tortilla, the dough can be sheeted and then severed, as for example by die cutting, from the sheet of dough into generally round precursors or preforms adapted for subsequent processing including cooking as by baking. Tortillas may also be formed by a method called press-forming wherein discrete and pre-weighed pieces of dough which were separated from the dough mass and are then put between two heated platens and pressed into the tortilla round shape to the desired thickness. The thus formed precursor is then further processed by cooking, e.g., by baking.

In the case of thicker bread-like items of this invention, the dough is formed into the desired shapes and placed on a conveyor belt for conveying through a cooking device for cooking. The dough may be cooked by any suitable cooking method, for example, radiant heat in an oven, frying, microwave cooking, etc. as are known.

### The Cooked Food Product

After cooking, the cooked food product will have different proportions of the ingredients predominantly because of the loss of moisture and other volatile components. The cooked food product is thin, having thickness in the range of about 0.5 mm through about 12 mm. In the case of a wheat based tortilla, the cooked tortilla has total comminuted material (on a dry weight basis) in the range of between about 70% and about 45% preferably in the range of between about 65% and about 50% and most preferably in the range of between about 60% and about 55% by weight of comminuted material, water and lipids and other plasticizers (if any). Water (total) is present in the cooked tortilla in the range of between about 42% and about 18% preferably in the range of between about 35% and about 25% and most preferably in the range of between about 33% and about 27% by total weight of comminuted material, water and lipids and other plasticizers (if any). Lipids (if any) are present in the range of between about 15% and about 0% preferably in the range of between about 12% and about 3% and most preferably in the range of between about 9% and about 6% by total weight of comminuted material, water and lipids and other plasticizers (if any). The cooked tortilla preferably has a thickness in the range of between about 0.5 mm and about 4 mm preferably in the range of between about 1 mm and about 3 mm and most preferably in the range of between about 1.5 mm and about 2.5 mm. It is recognized that the thickness will vary across the cooked product. Thin bread-like products such flat, pocket and pita breads have thickness in the range of between about 4 mm and about 12 mm as cooked and uncut.

With regard to other thin bread-like items such as pita, flat and pocket breads the cooked product has comminuted material (on a dry basis) in the range of between about 70% and about 40% preferably in the range of between about 65% and about 45% and most preferably in the range of between about 60% and about 50% by total weight of flour, water and lipids and other plasticizers (if any). Water (total) is present in the cooked product in the range of between about 45% and about 18% preferably in the range of between about 40% and about 27% and most preferably in the range of between about 35% and about 29% by weight of comminuted material, water and lipids and other plasticizers (if any). Lipids (if any) may be present in the cooked product in the range of between about 15% and about 0% preferably in the range of between about 12% and about 3% and most preferably in the range of between about 9% and about 6% by weight of comminuted material, water and lipids and other plasticizers (if any).

The cooked food product is then preferably packaged in a moisture resistant package for example a sealed plastic bag or package. The bag may be gas flushed as is known to provide an inert gas environment around the cooked food product. The bag may be formed of polyethylene, polypropylene or a multi-layered plastic bag comprising several polymers as is known in the art. The package retards the migration of moisture into or out of the product and also helps keep the cooked food product separated from the outside environment for microbial stability and other purposes. Such packaging is well known in the art.

### Method of Manufacture

The ingredients, the first and second components (comminuted material), water and lipids and other plasticizers (if any) are mixed together in any suitable manner to form a plastic mass of dough. If leavening is desired, the leavening agent is allowed to generate leavening gas in a manner known in the art, usually after the dough is developed, to expand the gas cells in the cooked product. In some dough making processes using yeast, a sponge dough method is used and in some methods a straight dough method is used as are known in the art. Chemical leavening may also be used. The dough is allowed to rise as desired in the process any time before the cooking or may even be allowed to rise during the cooking process. Leavening can occur before and/or during cooking. The dough is then further processed. In the case of sheeting of tortillas, the dough can be fed to a sheeting line where the dough is sheeted to the desired thickness. After sheeting, the sheeted dough is die cut to form the desired shaped and dimensioned preform. In the case of pressed tortillas, the dough is subdivided into smaller pieces which are fed to pressing platens to press the dough into the desired shape and thickness preform making them ready for subsequent processing. In the case of other thin bread-like items, the dough can be processed as is known in the art for example subdivided and allowed to rise at least some prior to the start of cooking. The preforms (precursors) formed by the just discussed processes are then ready for subsequent processing including cooking. The formed preforms are then suitably cooked as is known in the art. Preferably, when baking, the baking temperature is in the range of between about in the range of between about 300° F. and about 550° F. preferably in the range of between about 325° F. and about 500° F. and most preferably in the range of between about 350° F. and about 450° F. for a time sufficient to set the structure of the dough and obtain the desired coloring. Also, frying, microwaving and other cooking methods can be used as are known in the art and such cooking is conducted at a high enough temperature for a sufficient time to also set the structure of the cooked product and achieve the desired coloring. After cooking the product and depending upon the type of product and end result desired, the cooked product is placed into a package that is adequate to reduce the amount of moisture migration into and out of the cooked product during storage and provide microbial stability. The thus cooked and packaged product may be stored at a temperature in the range of between about −10° F. and about 85° F. and preferably in the range of between about 33° F. and about 85° F. for distribution and sale as well as storage by the consumer. Frozen storage is at a temperature at or about 32° F., preferred frozen storage is at a temperature in the range of between about −10° F. and about 32° F. and more preferred frozen storage is at a temperature in the range of between about 0° F. and about 10° F. Refrigerated storage is at a temperature in the range of between about 33° F. and about 50° F. and preferred refrigerated storage is at a temperature in the range of between about 35° F. and about 45° F. Ambient storage is at a temperature at or above about 51° F. and preferred ambient storage is at a temperature in the range of between about 51° F. and 85° F. and more preferred ambient storage is in the range of about 70° F. and 85° F. Some currently available tortillas, when stored at ambient temperature, have a shelf life of about 15 days. Preferably, in the case of tortillas of the present invention, the cooked product can be stored at ambient temperature. When stored frozen at about 10° F., the cooked food product (including tortillas) has a shelf life (as described below of maintaining flexibility above about 3.5) of greater than about 30 days, preferably at least about 45 days, more preferably at least about 60 days and most preferably at least about 90 days. When stored refrigerated at about 40° F., the cooked food product (including tortillas) has a shelf life (as described below of maintaining flexibility above about 3.5) of greater than about 30 days preferably at least about 45 days, more preferably at least about 60 days and most preferably at least about 90 days. When stored ambient at about 70° F., the shelf life (as described below of maintaining flexibility above about 3.5) of the cooked food product (including tortillas) is greater than about 30 days, preferably at least about 60 days and more preferably at least about 90 days. The shelf lives as just described and as defined in the claims for the various storage temperatures are test conditions since temperatures in an actual distribution system may vary considerably.

The cooked product exhibits a reduction in the rate of degradation. Degradation may be tested by the following tests which method is disclosed in U.S. Pat. No. 4,735,811, the disclosure of which is incorporated herein by reference.

A main mode of degradation failure of tortillas is breakage or cracking while being rolled without the tortilla being re-heated. Degradation can be tested by subjecting a tortilla to a stress test in which the product is randomly scrunched in one hand and squeezed for approximately three (3) seconds. The applied pressure is then released and the tortilla is allowed to return to its original flat shape. It is then examined for stress cracks or fold lines and given a score based on its appearance after the “flex test”. The inventive tortilla as disclosed herein receives flexibility ratings which permit it to be used for the wrapping/rolling procedures just described which typifies tortilla use—cracks are non-existent and fold lines are only vaguely visible. Flexibility scoring is by visual evaluation with a rating of 5 being ideal and 1 being the worst rating. The following are the ratings:

5=no fold lines

4=fold lines barely visible

3.5=fold lines clearly visible; slight edge cracking

3=more edge cracking; some cracking in center

2=breaks up into two to three large pieces

1=broken into many small pieces

The following examples, as tabulated in table 1, illustrate the operability of the present invention. The products were scored after being stored at ambient temperature with control failing after seven days of storage, Example 1 failing after 85 days of storage, Example 2 failing after 30 days of storage, and Example 3 failing after 91 days of storage. Failure was set at achieving a consistent score of less than 4.0.

TABLE I

| | Control | Example 1 | Example 2 | Example 3 |
|---|---|---|---|---|
| Flour | 60.60 | 39.71 | 44.26 | 35.25 |
| Water | 28.00 | 32.00 | 30.00 | 36.53 |
| Soy oil | 5.40 | 5.20 | 5.20 | |
| Glycerin | 3.10 | 4.30 | 4.30 | 4.60 |
| Baking powder (SALP and | 1.20 | 0.90 | 1.20 | 1.27 |
| baking soda) | | | | |
| Potassium sorbate | 0.26 | 0.48 | 0.48 | 0.51 |
| Fumaric acid | 0.24 | | 0.20 | 0.20 |
| Salt | 1.20 | 1.40 | 1.40 | 1.51 |
| SALP | | 1.05 | | |
| Emulsifier (hydrated | | 0.60 | 0.60 | 0.63 |
| monoglyceride) | | | | |
| CMC | | 0.36 | 0.36 | 1.02 |
| Wheat gluten | | 4.00 | 4.00 | 3.06 |
| Pregel 46 (Wheat) | | 4.00 | | |
| Midsol 46 (Wheat) | | 6.00 | | |
| X-PAND'R 612 (Corn) | | | 8.00 | |
| XB-951 (Potato) | | | | 15.42 |
| | 100.00 | 100.00 | 100.00 | 100.00 |

Pregel 46 is a wheat starch available from Midwest Grain Products, Inc. and is believed to be substituted, crosslinked and pregelled. Midsol 46 is also a wheat starch and available from Midwest Grain Products, Inc. and is believed to be substituted and crosslinked, X-PAND'R 612 is a corn starch available from A. E. Staley and is believed to be modified by pregelatinization and XB-951 is a potato starch available from Penwest Foods Company and believed to be modified by substitution, pregelatinization and crosslinking.

As can be seen, the control tortilla failed after seven days. Examples 1, 2 and 3 all showed significantly extended shelf life as shelf life relates to cracking which is an indication of product degradation which is believed to principally be staling. Examples 1 and 3 were particularly effective at avoiding degradation.

Thus, there has been shown and described several embodiments of a staling resistant tortilla. As is evident from the foregoing description, certain aspects of the present invention are not limited by the particular details of the examples illustrated herein and it is therefore contemplated that other modifications and applications, or equivalents thereof, will occur to those skilled in the art. Many changes, modifications, variations and other uses and applications of the present constructions will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A thin degradation resistant cooked comminuted material based food product formed from a dough, said food product comprising:
comminuted material and plasticizer wherein:
the comminuted material includes a protein and starch containing material in the range of between about 70% and about 40% on a dry weight basis by weight of cooked food product, a portion of the starch of the comminuted material includes modified starch at least a portion of which was modified prior to forming a precursor to the cooked food product, said modified starch being present in a weight ratio in the range of between about 1.2:1 and about 1:50 by weight of the remainder of the starch on a dry weight basis; and
the plasticizer includes water, wherein the plasticizer is present in an amount in a dough from which the food product is formed to form a dough from the comminuted material and plasticizer and wherein the modified starch is effective to provide the cooked product a shelf life of at least about 30 days.

2. A food product as set forth in claim 1 wherein the plasticizer includes water and lipid, if any lipid, wherein:
the comminuted material includes flour and/or masa;
the water is in the range of between about 45% and about 18% by weight of comminuted material plus plasticizer; and
lipid in the range of between about 15% and about 0% by weight of comminuted material plus plasticizer.

3. A food product as set forth in claim 2 wherein the flour includes seed crop flour.

4. A food product as set forth in claim 3 wherein the flour includes wheat flour.

5. A food product as set forth in claim 4 wherein the food product is a tortilla.

6. A food product as set forth in claim 5 wherein the tortilla has a thickness in the range of between about 0.5 mm and about 4 mm.

7. A food product as set forth in claim 6 wherein the food product is stored under refrigerated conditions.

8. A food product as set forth in claim 6 wherein the food product is stored under ambient conditions.

9. A food product as set forth in claim 6 wherein the food product is stored under frozen conditions.

10. A food product as set forth in claim 6 wherein gluten is added to the comminuted material to be part thereof prior to forming the precursor with the gluten being added in an amount such that the total protein is in the range of between about 20% and about 10% by weight of comminuted material on a dry weight basis.

11. A food product as set forth in claim 10 herein the added gluten is present in the range of between about 18% and about 12% by weight of comminuted material on a dry weight basis and the modified starch is present in a weight ratio in the range of between about 1.2:1 and about 1:20 by weight of the remainder of the starch on a dry weight basis.

12. A food product as set forth in claim 10 wherein the modified starch is substantially completely gelatinized prior to forming a precursor to the cooked food product.

13. A food product as set forth in claim 10 wherein the modified starch includes chemically modified starch.

14. A food product as set forth in claim 13 wherein the chemically modified starch includes oxidized starch.

15. A food product as set forth in claim 13 wherein the chemically modified starch includes crosslinked starch.

16. A food product as set forth in claim 13 wherein the chemically modified starch includes substituted starch.

17. A food product as set forth in claim 16 wherein the substituted starch includes hydroxypropyllated starch.

18. A food product as set forth in claim 1 wherein the food product has a thickness in the range of between about 0.5 mm and about 12 mm.

19. A cooked tortilla comprising:
flour and/or masa and plasticizer wherein:
the flour and/or masa is present in an amount, on a dry weight basis, in the range of between about 70% and about 45% by weight of flour and/or masa and plasticizer;
the plasticizer includes water in an amount in the range of between about 42% and about 18% by weight of flour and/or masa and plasticizer; and
a portion of said flour and/or masa being a modified starch in a quantity such that the cooked tortilla has a shelf life, when stored at a temperature in the range of between about −10° F. and about 85° F. of at least about 30 days.

20. A cooked tortilla as set forth in claim 19 wherein the flour includes wheat flour.

21. A cooked tortilla as set forth in claim 20 wherein the flour is at least a majority wheat flour.

22. A cooked tortilla as set forth in claim 21 wherein the flour and/or masa includes a protein component and a starch component and wherein the starch component includes the modified starch that was pre-gelatinized prior to adding to a precursor of the cooked tortilla.

23. A cooked tortilla as set forth in claim 21 wherein the modified starch was modified prior to adding to a precursor of the cooked tortilla, said modified starch including hydroxypropyllated starch.

24. A cooked tortilla as set forth in claim 21 wherein the modified starch component was modified prior to addition to a precursor of the cooked tortilla, said modified starch including crosslinked starch, hydroxypropyllated starch and pre-gelatinized starch.

25. A cooked tortilla as set forth in claim 22 wherein the modified starch component was modified prior to addition to a precursor of the cooked tortilla, said modified starch including oxidized starch.

26. A cooked tortilla as set forth in claim 19 wherein the cooked tortilla has a shelf life of at least about 30 days when stored at a temperature of about 70° F.

27. A cooked tortilla as set forth in claim 19 wherein the cooked tortilla has a shelf life of at least about 45 days when stored at a temperature of about 40° F.

28. A cooked tortilla as set forth in claim 19 wherein the cooked tortilla has a shelf life of at least about 30 days when stored at a temperature of about 10° F.

29. A method of making a degradation resistant tortilla, said method including:
forming a plastic mixture of flour and/or masa and water, said flour and/or masa including a starch component and a protein component said starch component including a first fraction and a second fraction with the second fraction being present in a weight ratio in the range of between about 1.2:1 and about 1:50 to the first fraction on a dry basis, said second fraction including modified starch;
forming at least a portion of the plasticized mixture into a precursor to a cooked tortilla;
cooking the precursor sufficiently to form a cooked tortilla;
enclosing the cooked tortilla in a moisture migration resistant package; and
storing the enclosed tortilla at a temperature in the range of between about −10° F. and about 85° F. and the tortilla having resistance to degradation for at least about 30 days.

30. A method as set forth in claim 29 wherein the second fraction includes pre-gelatinized starch.

31. A method as set forth in claim 30 where the pre-gelatinized starch is present in the plastic mass in a weight ratio in the range of between about 1:1.2 and about 1:20 to the first fraction on a dry basis.

32. A method as set forth in claim 29 wherein the second fraction includes hydroxypropyllated starch.

33. A method as set forth in claim 29 wherein the plastic mixture is sheeted to form a sheet and said precursor is separated from the sheet and is cooled after separation.

34. A method as set forth in claim 29 wherein at least a portion of the plastic mass is formed into a precursor by press forming prior to cooking.

35. A thin degradation resistant cooked flour based food product formed from a dough, said food product comprising:
flour and plasticizer wherein;
the flour includes a protein and starch containing flour in the range between about 70% and about 40% on a dry weight basis by weight of cooked food product. A portion of the starch of the flour includes modified starch at least a portion of which was modified prior to forming a precursor to the cooked food product, said modified starch being present in an amount effective to provide the cooked product a shelf life of at least about 30 days when stored at about 70° F.; and
the plasticizer includes water, wherein the plasticizer is present in an amount in a dough from which the food product is formed to form a dough from the flour and plasticizer.

36. A thin degradation resistant cooked the flour based food product formed from a dough, said food product comprising:
flour and plasticizer wherein;
the flour includes a protein and starch containing flour in the range of between about 70% and about 40% on a dry weight basis by weight of cooked food product, a portion of the starch of the flour includes modified starch at least a portion of which was modified prior to forming a precursor to the cooked food product, said modified starch being present in an amount effective to provide the cooked food product a shelf life of at least about 45 days when stored at about 40° F.; and
the plasticizer includes water, wherein the plasticizer is present in an amount in a dough from which the cooked food product is formed to form a dough from the flour and plasticizer.

37. A thin degradation resistant cooked flour based food product formed from a dough, said food product comprising:
flour and plasticizer wherein;
the flour includes a protein and starch containing flour in the range of between about 70% and about 40% on a dry weight basis by weight of cooked food product, a portion of the starch of the flour includes modified starch derived from a cereal grain and/or legume, at least a portion of which was modified prior to forming a precursor to the cooked food product, said modified starch being present in a weight ratio in the range of between about 1.2:1 and about 1:50 by weight of the remainder of the starch on a dry weight basis; and
the plasticizer includes water, wherein the plasticizer is present in an amount in a dough from which the food product is formed to form a dough from the flour and plasticizer.

38. A food product as set forth in claim 37 wherein the cooked food product has a shelf life of at least about 30 days.
